(19) United States
(12) Patent Application Publication
(10) Pub. No.: US 2019/0105758 A1
(43) Pub. Date: Apr. 11, 2019

(54) Socket Assembly

(71) Applicant: PLUS CRAFT INDUSTRIAL CO., LTD., Taichung City (TW)

(72) Inventor: Timmy Chen, Taichung City (TW)

(21) Appl. No.: 15/725,309

(22) Filed: Oct. 5, 2017

(51) Int. Cl. B25B 13/10

(52) U.S. Cl. CPC B25B 13/102

(57) ABSTRACT

A socket assembly includes an outer socket and a first movable socket mounted in the outer socket. The outer socket is provided with a receiving chamber having a peripheral wall provided with a plurality of drive blocks and a plurality of retaining grooves. The first movable socket is movably mounted in the receiving chamber and includes a base and a plurality of driving pieces provided on the base. An elastic member is biased between the base and the outer socket. Each of the driving pieces has a first side provided with a restriction portion slidably mounted in one of the retaining grooves and a second side provided with a driving portion which has a pressing face.

### BACKGROUND OF THE INVENTION

### 1. Field of the Invention

The present invention relates to a hand tool and, more particularly, to a socket assembly.

### 2. Description of the Related Art

A conventional socket assembly in accordance with the prior art shown in FIGS. 1-5 is used to operate nuts of two different sizes, and comprises an outer socket 1 and an inner socket 2. The outer socket 1 has a first end provided with a tool connector 11 and a second end provided with a workpiece connector 12. The workpiece connector 12 has an interior provided with a first mounting section 13 which has a hexagonal shape and has an inner diameter “HEX1”. The outer socket 1 has a periphery provided with a screw bore 14 connected to the first mounting section 13. The inner socket 2 has an interior provided with a second mounting section 21 which has a hexagonal shape and has an inner diameter “HEX2”. The inner socket 2 has an outer wall 22 mounted in the first mounting section 13 of the outer socket 1. The inner socket 2 has a periphery provided with an elongate slot 23 having a front end and a rear end 231. A limit member 25 is screwed through the screw bore 14 of the outer socket 1 and received in the elongate slot 23. An elastic member 24 is mounted in the first mounting section 13 of the outer socket 1 and biased between the inner socket 2 and the outer socket 1 so that the limit member 25 rests on the rear end 231 of the elongate slot 23 at a normal state as shown in FIG. 3.

In operation, referring to FIG. 6 with reference to FIGS. 1-5, the conventional socket assembly is used to mount and operate a nut 9 with a smaller size which is smaller than that of the second mounting section 21 of the inner socket 2. The tool connector 11 is driven by a motorized or hand tool. The nut 9 is mounted in the second mounting section 21 of the inner socket 2, and the second mounting section 21 of the inner socket 2 is mounted in the first mounting section 13 of the outer socket 1, so that when the outer socket 1 is rotated, the inner socket 2 is rotated to drive the nut 9 so as to lock or unlock the nut 9. Alternatively, referring to FIG. 7 with reference to FIGS. 1-5, the conventional socket assembly is used to mount and operate a nut 91 with a larger size which is greater than that of the second mounting section 21 of the inner socket 2. When the nut 91 is inserted into the first mounting section 13 of the outer socket 1, the inner socket 2 is pushed by the nut 91 to move toward the first mounting section 13 of the outer socket 1 and to compress the elastic member 24. At this time, the limit member 25 is moved in the elongate slot 23. Thus, the nut 91 is mounted in the first mounting section 13 of the outer socket 1, so that when the outer socket 1 is rotated, the outer socket 1 directly drives the nut 9 so as to lock or unlock the nut 9. Therefore, the conventional socket assembly is used to operate nuts 9 and 91 of two different sizes.

In practice, a nut has various successive sizes of 9 mm, 11 mm, 13 mm, 15 mm, 17 mm, 19 mm, 21 mm, 23 mm, etc., and the operator usually needs to prepare two continuous sizes of the inner socket 2 and the outer socket 1, such as 9 mm and 11 mm, or 11 mm and 13 mm, or 13 mm and 15 mm, or 15 mm and 17 mm, or the like, to facilitate the working procedure. When the inner diameter “HEX1” of the first mounting section 13 of the outer socket 1 is 15 mm, and the inner diameter “HEX2” of the second mounting section 21 of the inner socket 2 is 13 mm, the thickness of the inner socket 2 is equal to (HEX1-HEX2)÷2, and equal to 1 mm after calculation. Thus, when two continuous sizes are needed, the thickness of the inner socket 2 is only 1 mm, which is not large enough to tolerate the torque applied on the inner socket 2, so that the inner socket 2 is easily deformed due to an excessive torque. In conclusion, the inner socket 2 needs to have a determined thickness to withstand the applied torque, and the thickness is greater than 1 mm, such that the inner socket 2 and the outer socket 1 cannot have two continuous sizes. Thus, the conventional socket assembly only provides the inner socket 2 and the outer socket 1 of two discontinuous sizes, so that the conventional socket assembly is only available for operating two discontinuous sizes of nuts 9 and 91, such as 13 mm and 17 mm, or 15 mm and 19 mm or the like, and cannot be used to operate two continuous sizes of nuts 9 and 91, such as 13 mm and 15 mm, or 15 mm and 17 mm or the like, thereby limiting the versatility of the conventional socket assembly.

Referring to FIG. 8, the conventional socket assembly further comprises a second inner socket 3 mounted in the inner socket 2 so that the conventional socket assembly is used to operate nuts of three different sizes.

### BRIEF SUMMARY OF THE INVENTION

The primary objective of the present invention is to provide a socket assembly having a thicker movable socket and having a greater strength so as to operate nuts of continuous sizes.

In accordance with the present invention, there is provided a socket assembly comprising an outer socket and a first movable socket mounted in the outer socket. The outer socket has a first end provided with a tool connector and a second end provided with a workpiece connector. The workpiece connector of the outer socket has an interior provided with a receiving chamber. The receiving chamber of the outer socket has a peripheral wall provided with a plurality of drive blocks and a plurality of retaining grooves arranged between the drive blocks. The first movable socket is movably mounted in the receiving chamber of the outer socket and includes a base and a plurality of driving pieces provided on the base. An elastic member is mounted in the receiving chamber of the outer socket and is biased between the base and the outer socket. Each of the driving pieces of the first movable socket has a first side provided with a restriction portion slidably mounted in one of the retaining grooves of the outer socket and a second side provided with a driving portion which has an inner diameter provided with a pressing face. The driving portion of each of the driving pieces extends into the receiving chamber of the outer socket and has a conic face tapered toward the pressing face.

According to the primary advantage of the present invention, the restriction portion of each of the driving pieces of the first movable socket is limited in one of the retaining grooves of the outer socket to increase the strength of the driving portion, thereby enhancing the strength of the first movable socket 5.

According to another advantage of the present invention, the restriction portion of each of the driving pieces of the first movable socket increases the strength of the driving portion, so that the thickness of the driving portion can be reduced, to satisfy the requirement of various variations of the nuts of different sizes.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional socket assembly in accordance with the prior art.

FIG. 2 is an exploded perspective view of the conventional socket assembly as shown in FIG. 1.

FIG. 3 is a partially planar cross-sectional view of the conventional socket assembly as shown in FIG. 1.

FIG. 4 is a side cross-sectional view of an outer socket of the conventional socket assembly.

FIG. 5 is a side cross-sectional view of the conventional socket assembly as shown in FIG. 1.

FIG. 6 is a schematic side operational view of the conventional socket assembly as shown in FIG. 1.

FIG. 7 is another schematic side operational view of the conventional socket assembly as shown in FIG. 1.

FIG. 8 is a perspective view of another conventional socket assembly in accordance with the prior art.

FIG. 9 is a perspective view of a socket assembly in accordance with the preferred embodiment of the present invention.

FIG. 10 is an exploded perspective view of the socket assembly as shown in FIG. 9.

FIG. 11 is a front planar cross-sectional view of the socket assembly as shown in FIG. 9.

FIG. 12 is a side cross-sectional view of an outer socket of the socket assembly in accordance with the preferred embodiment of the present invention.

FIG. 13 is a side cross-sectional view of the socket assembly as shown in FIG. 9.

FIG. 14 is a schematic side operational view of the socket assembly as shown in FIG. 9.

FIG. 15 is another schematic side operational view of the socket assembly as shown in FIG. 9.

FIG. 16 is a schematic side view of the socket assembly as shown in FIG. 9.

FIG. 17 is a schematic side view of a socket assembly in accordance with another preferred embodiment of the present invention.

FIG. 18 is a schematic side view of a socket assembly in accordance with another preferred embodiment of the present invention.

FIG. 19 is a side view of a socket assembly in accordance with another preferred embodiment of the present invention.

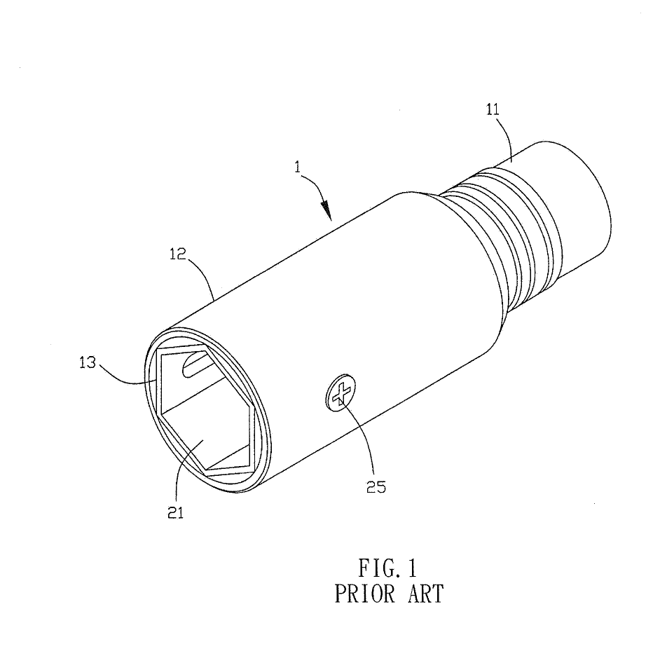

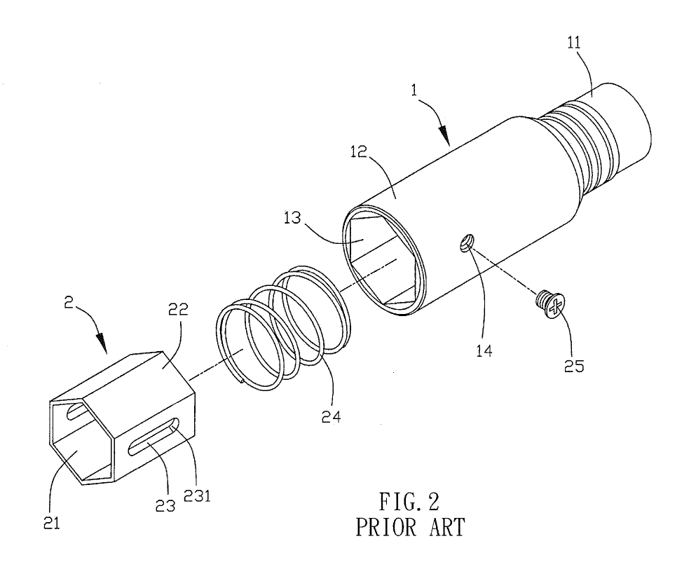

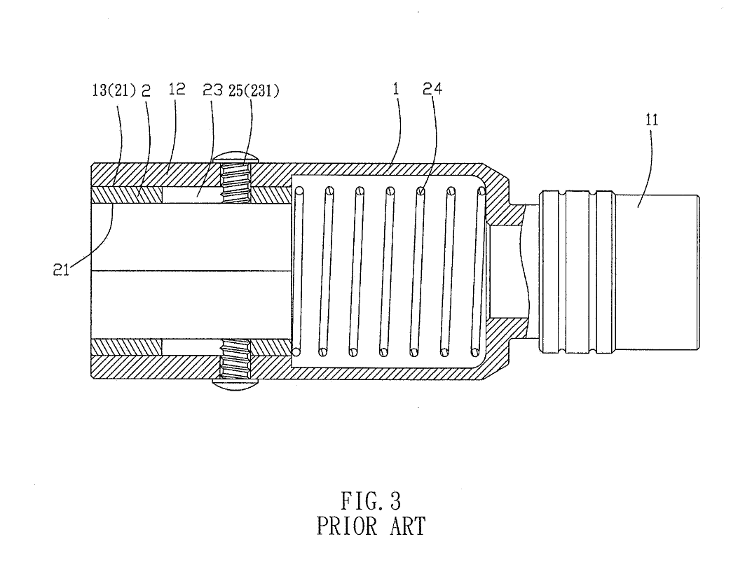

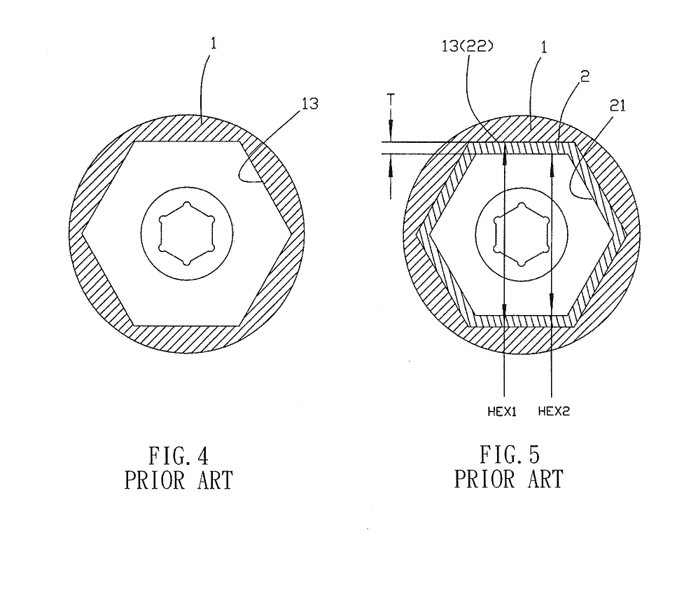

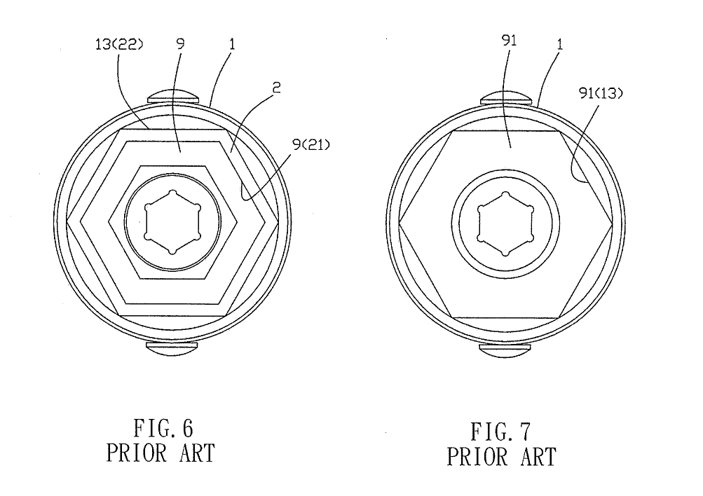

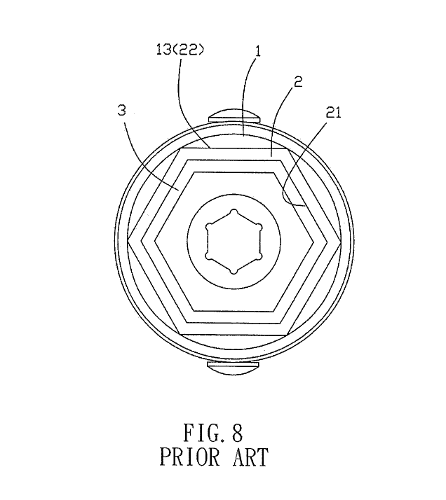

### DETAILED DESCRIPTION OF THE INVENTION

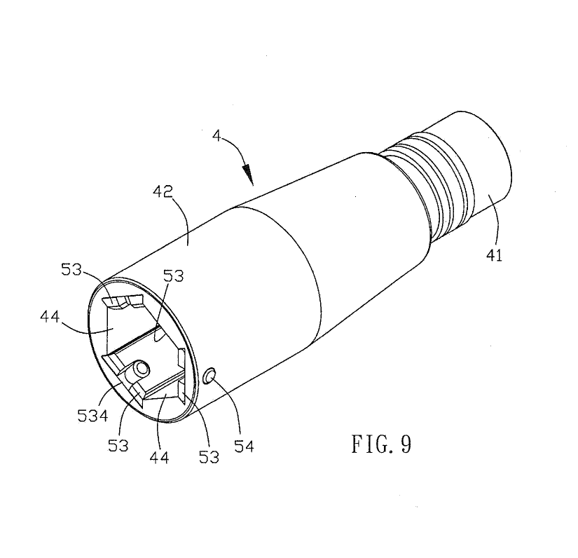

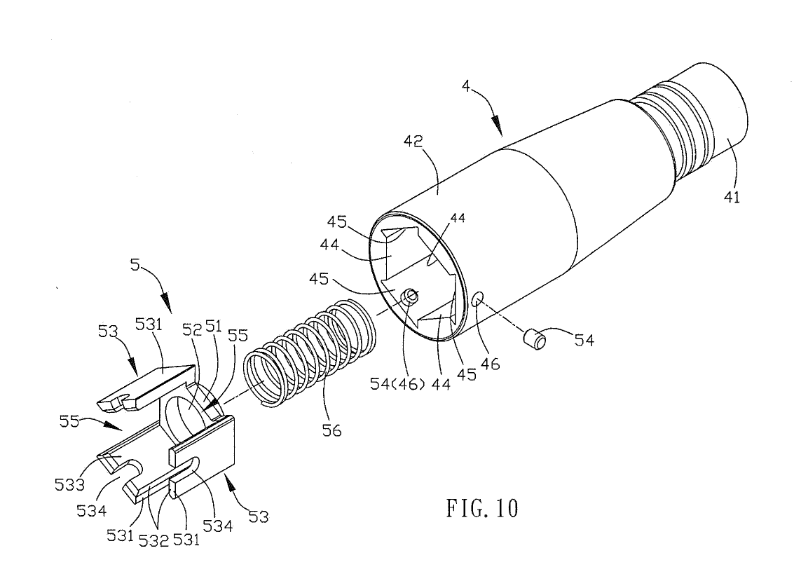

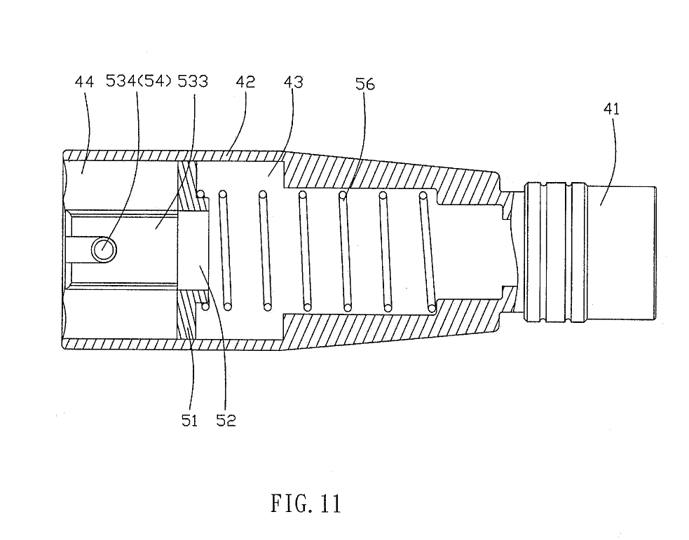

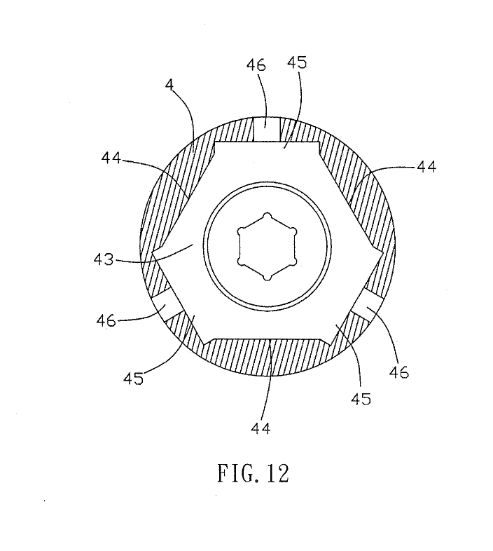

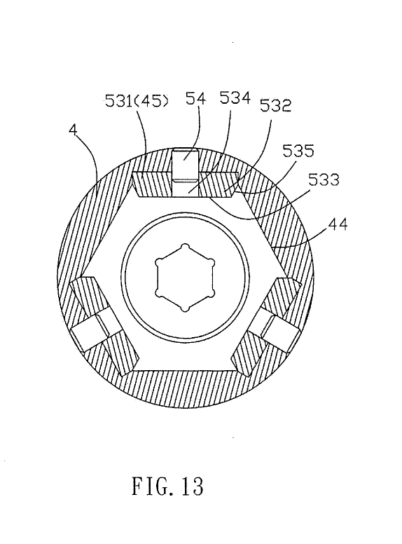

Referring to the drawings and initially to FIGS. 9-13, a socket assembly in accordance with the preferred embodiment of the present invention comprises an outer socket 4 and a first movable socket 5 mounted in the outer socket 4.

The outer socket 4 has a first end provided with a tool connector 41 and a second end provided with a workpiece connector 42. The workpiece connector 42 of the outer socket 4 has an interior provided with a receiving chamber 43. The receiving chamber 43 of the outer socket 4 has a peripheral wall provided with a plurality of drive blocks 44 and a plurality of retaining grooves 45 arranged between the drive blocks 44. Preferably, the outer socket 4 has three drive blocks 44 and three retaining grooves 45. The drive blocks 44 and the retaining grooves 45 are arranged in an annular manner and are arranged equidistantly, successively and contiguously. Each of the retaining grooves 45 extends radially and outwardly from two adjacent drive blocks 44.

The first movable socket 5 is movably mounted in the receiving chamber 43 of the outer socket 4 and includes a base 51 and a plurality of driving pieces 53 provided on the base 51. An elastic member 56 is mounted in the receiving chamber 43 of the outer socket 4 and is biased between the base 51 and the outer socket 4. The base 51 of the first movable socket 5 is provided with a shaft hole 52. The driving pieces 53 of the first movable socket 5 extend forward from the base 51 and are arranged in an annular manner. Each of the driving pieces 53 of the first movable socket 5 has a first side provided with a restriction portion 531 slidably mounted in one of the retaining grooves 45 of the outer socket 4 and a second side provided with a driving portion 532 which has an inner diameter provided with a pressing face 533. The restriction portion 531 and the driving portion 532 of each of the driving pieces 53 are formed integrally. The driving portion 532 of each of the driving pieces 53 extends into the receiving chamber 43 of the outer socket 4 and has a conic face 535 tapered toward the pressing face 533.

In the preferred embodiment of the present invention, the drive blocks 44 and the retaining grooves 45 of the outer socket 4 form an inner diameter of the receiving chamber 43.

In the preferred embodiment of the present invention, the outer socket 4 has a periphery provided with a plurality of through holes 46 connected to the retaining grooves 45, each of the driving pieces 53 is provided with a guide slot 534 connected to one of the through holes 46 of the outer socket 4, and a plurality of limit members 54 extend through the through holes 46 of the outer socket 4 into the retaining grooves 45. Each of the limit members 54 is limited in the guide slot 534 of one of the driving pieces 53. Thus, the first movable socket 5 is movable in the receiving chamber 43 of the outer socket 4, and each of the driving pieces 53 of the first movable socket 5 is movable in one of the retaining grooves 45 of the outer socket 4 and limited by one of the limit members 54.

In the preferred embodiment of the present invention, each of the limit members 54 has a first end secured in one of the through holes 46 of the outer socket 4 by riveting and a second end which is fully received in and does not protrude from the guide slot 534 of one of the driving pieces 53.

In the preferred embodiment of the present invention, the restriction portion 531 of each of the driving pieces 53 has a thickness equal to or greater than that of the driving portion 532.

In the preferred embodiment of the present invention, the first movable socket 5 further includes a plurality of openings 55 defined between the driving pieces 53 and receiving the drive blocks 44 of the outer socket 4. Preferably, the first movable socket 5 includes three driving pieces 53 and three openings 55.

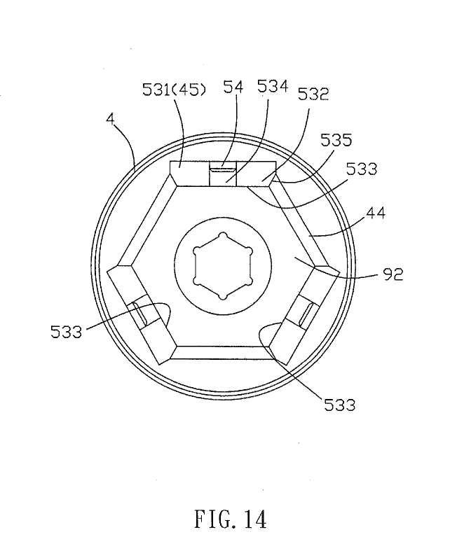

In operation, referring to FIG. 14 with reference to FIGS. 9-13, the socket assembly is used to mount and operate a nut 92 with a smaller size. The tool connector 41 is driven by a motorized or hand tool. The restriction portion 531 of each of the driving pieces 53 is mounted in one of the retaining grooves 45 of the outer socket 4, and the driving pieces 53 of the first movable socket 5 are mounted on the nut 92 with the pressing face 533 pressing the nut 92. Thus, when the outer socket 4 is rotated, the first movable socket 5 is also rotated to drive the nut 92 so as to lock or unlock the nut 92.

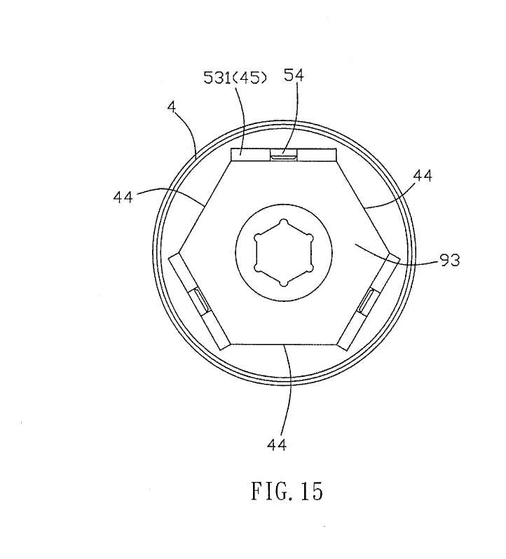

Alternatively, referring to FIG. 15 with reference to FIGS. 9-13, the socket assembly is used to mount and operate a nut 93 with a smaller size. The nut 93 has an outer diameter greater than the inner diameter of the driving pieces 53 of the first movable socket 5, so that when the driving pieces 53 of the first movable socket 5 are mounted on the nut 93, the first movable socket 5 is pushed by the nut 93 and is retracted into the receiving chamber 43 of the outer socket 4 to compress the elastic member 56. At the same time, the nut 93 is inserted into the receiving chamber 43 of the outer socket 4 and engages the drive blocks 44 of the outer socket 4. Thus, when the outer socket 4 is rotated, the outer socket 4 directly drives the nut 93 so as to lock or unlock the nut 93. When the first movable socket 5 is moved relative to the outer socket 4, each of the limit members 54 is limited in the guide slot 534 of one of the driving pieces 53. When the nut 93 is removed from the outer socket 4, the first movable socket 5 is pushed outward by the restoring force of the elastic member 56. Therefore, the socket assembly is used to operate nuts 92 and 93 of two different sizes.

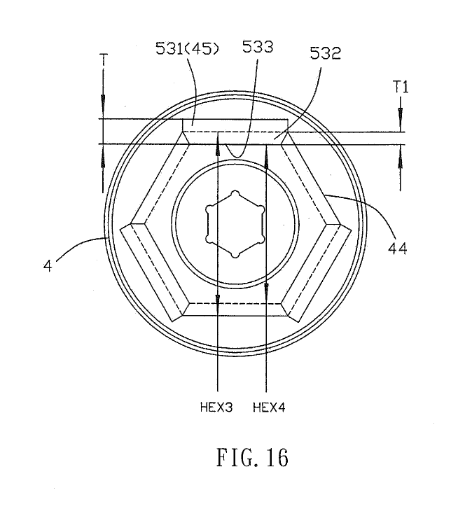

Referring to FIG. 16 with reference to FIGS. 9-13, the drive blocks 44 of the outer socket 4 have an inner diameter “HEX3” which is equal to the inner diameter “HEX1” of the first mounting section 13 of the conventional socket assembly, the pressing faces 533 of the driving pieces 53 of the first movable socket 5 have an inner diameter “HEX4” which is equal to the inner diameter “HEX2” of the second mounting section 21 of the conventional socket assembly, the restriction portions 531 of the driving pieces 53 of the first movable socket 5 have a thickness “T1”, and the first movable socket 5 has a thickness “T”.

In calculation, the thickness “T” of the first movable socket 5 is determined by the following equation:

T=HEX3−HEX4+T1

Thus, the thickness “T” of the first movable socket 5 is larger than that of the inner socket 2 of the conventional socket assembly, with an increase of the thickness “T1” of the restriction portions 531 of the driving pieces 53 of the first movable socket 5, so that the first movable socket 5 has an enhanced strength.

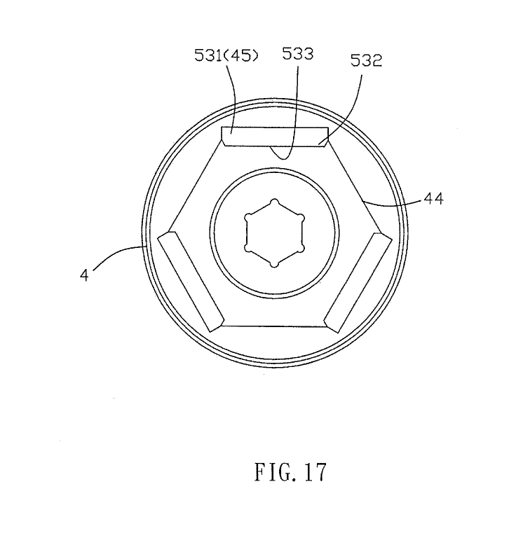

Referring to FIG. 17, according to the equation of T=HEX3-HEX4+T1, when the thickness “T1” of the restriction portions 531 of the driving pieces 53 of the first movable socket 5 is large enough to withstand the force applied on the first movable socket 5, the differential value (or HEX3-HEX4) between the inner diameter “HEX3” of the drive blocks 44 and the inner diameter “HEX4” of the pressing faces 533 is shortened. Thus, the inner diameter “HEX4” of the pressing faces 533 can be increased from 13 mm to 13.5 mm, 14 mm or 14.5 mm to shorten the differential value (or HEX3-HEX4), so as to have variations of multiple sizes.

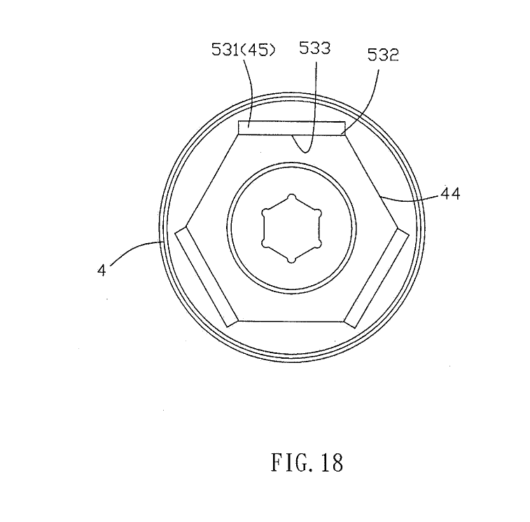

Referring to FIG. 18, when the nut has a size of 9/16″ or 14.2875 mm, the socket with a size of 15 mm is used to operate the nut of 9/16″. However, a clearance is defined between the socket of 15 mm and the nut of 9/16″, so that the socket easily slips on the nut, thereby wearing the nut during a long-term utilization. In the preferred embodiment of the present invention, the differential value between the inner diameter “HEX3” of the drive blocks 44 and the inner diameter “HEX4” of the pressing faces 533 is shortened to the maximum. For example, the inner diameter “HEX3” of the drive blocks 44 is set to 15 mm, and the inner diameter “HEX4” of the pressing faces 533 is set to 9/16″, so that the socket assembly provides two sockets with little size difference. In addition, the pressing face 533 of each of the driving pieces 53 of the first movable socket 5 is supported by the restriction portion 531 and has an enhanced the strength. Thus, the socket assembly is available for combination of the metric system and the British system.

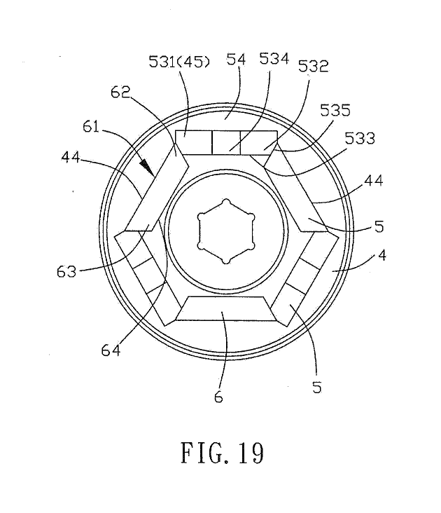

Referring to FIG. 19, the socket assembly further comprises a second movable socket 6 mounted on the first movable socket 5. The second movable socket 6 has a structure similar to that of the first movable socket 5 and includes a plurality of driving pieces 61 arranged in an annular manner. Preferably, the second movable socket 6 includes three driving pieces 61. Each of the driving pieces 61 of the second movable socket 6 has a back face resting on one of the drive blocks 44 of the outer socket 4. Each of the driving pieces 61 of the second movable socket 6 has a first side provided with a restriction portion 62 mounted between two adjacent conic faces 535 of the first movable socket 5 and a second side provided with a driving portion 63 which has an inner diameter provided with a pressing face 64. The restriction portion 62 and the driving portion 63 of each of the driving pieces 61 of the second movable socket 6 are formed integrally. The driving portion 63 of each of the driving pieces 61 of the second movable socket 6 extends into the receiving chamber 43 of the outer socket 4. Thus, the socket assembly is used to operate nuts of three different sizes.

Accordingly, the restriction portion 531 of each of the driving pieces 53 of the first movable socket 5 is limited in one of the retaining grooves 45 of the outer socket 4 to increase the strength of the driving portion 532, thereby enhancing the strength of the first movable socket 5. In addition, the restriction portion 531 of each of the driving pieces 53 of the first movable socket 5 increases the strength of the driving portion 532, so that the thickness of the driving portion 532 can be reduced, to satisfy the requirement of various variations of the nuts of different sizes.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A socket assembly comprising:
an outer socket; and
a first movable socket mounted in the outer socket;
wherein:
the outer socket has a first end provided with a tool connector and a second end provided with a workpiece connector;
the workpiece connector of the outer socket has an interior provided with a receiving chamber;
the receiving chamber of the outer socket has a peripheral wall provided with a plurality of drive blocks and a plurality of retaining grooves arranged between the drive blocks;
the first movable socket is movably mounted in the receiving chamber of the outer socket and includes a base and a plurality of driving pieces provided on the base;
an elastic member is mounted in the receiving chamber of the outer socket and is biased between the base and the outer socket;
each of the driving pieces of the first movable socket has a first side provided with a restriction portion slidably mounted in one of the retaining grooves of the outer socket and a second side provided with a driving portion which has an inner diameter provided with a pressing face; and
the driving portion of each of the driving pieces extends into the receiving chamber of the outer socket and has a conic face tapered toward the pressing face.

2. The socket assembly of claim 1, wherein the drive blocks and the retaining grooves of the outer socket form an inner diameter of the receiving chamber.

3. The socket assembly of claim 1, wherein:
the drive blocks and the retaining grooves are arranged in an annular manner and are arranged equidistantly, successively and contiguously;
each of the retaining grooves extends radially and outwardly from two adjacent drive blocks;
the base of the first movable socket is provided with a shaft hole;
the driving pieces of the first movable socket extend forward from the base and are arranged in an annular manner; and
the restriction portion and the driving portion of each of the driving pieces are formed integrally.

4. The socket assembly of claim 1, wherein:
the outer socket has a periphery provided with a plurality of through holes connected to the retaining grooves;
each of the driving pieces is provided with a guide slot connected to one of the through holes of the outer socket;
a plurality of limit members extend through the through holes of the outer socket into the retaining grooves; and
each of the limit members is limited in the guide slot of one of the driving pieces.

5. The socket assembly of claim 4, wherein each of the limit members has a first end secured in one of the through holes of the outer socket by riveting and a second end which is fully received in and does not protrude from the guide slot of one of the driving pieces.

6. The socket assembly of claim 1, wherein the restriction portion of each of the driving pieces has a thickness equal to or greater than that of the driving portion.

7. The socket assembly of claim 1, wherein the first movable socket further includes a plurality of openings defined between the driving pieces and receiving the drive blocks of the outer socket.

8. The socket assembly of claim 1, further comprising:
a second movable socket mounted on the first movable socket;
wherein:
the second movable socket includes a plurality of driving pieces arranged in an annular manner;
each of the driving pieces of the second movable socket has a back face resting on one of the drive blocks of the outer socket; and
each of the driving pieces of the second movable socket has a first side provided with a restriction portion mounted between two adjacent conic faces of the first movable socket and a second side provided with a driving portion which has an inner diameter provided with a pressing face.

9. The socket assembly of claim 8, wherein:
the restriction portion and the driving portion of each of the driving pieces of the second movable socket are formed integrally; and
the driving portion of each of the driving pieces of the second movable socket extends into the receiving chamber of the outer socket.
